(19) United States
(12) Patent Application Publication
(10) Pub. No.: US 2025/0380681 A1
(43) Pub. Date: Dec. 18, 2025

(54) DISPOSABLE EQUINE ICE BOOT

(71) Applicant: Monty L. RUETENIK, Clear Lake City, TX (US)

(72) Inventor: Monty L. RUETENIK, Clear Lake City, TX (US)

(21) Appl. No.: 19/262,572

(22) Filed: Jul. 8, 2025

Related U.S. Application Data
(60) Provisional application No. 63/659,131, filed on Jun. 12, 2024.

(51) Int. Cl. A01L 15/00; A01L 3/00

(52) U.S. Cl. CPC A01L 15/00; A01L 3/00

(57) ABSTRACT

A disposable ice cooling reservoir and an ice boot assembly with the reservoir that is useful for treatment of lameness and stress is described. The reservoir is a bag with closed bottom that is equipped with a one-way fluid valve midway up the bag, and a reinforced rim with fasteners for attaching the reservoir to a separate harness. The bag is available separately, but in use is combined with an orthotic insert, and ankle bootlet and a sole plate. To assemble, the orthotic insert is put into the bottom of the ankle bootlet, which is put into the bottom of the reservoir bag. This partial assembly is then fitted into the sole plate, and reversibly fastened thereto, such as with barbed rivets through the sole plate and the base of the ankle bootlet.

### PRIOR RELATED APPLICATIONS

This application claims priority to U.S. Ser. No. 63/659,131, filed Jun. 12, 2024 and incorporated by reference in its entirety for all purposes.

### FEDERALLY SPONSORED RESEARCH STATEMENT

Not applicable.

### FIELD OF THE DISCLOSURE

This invention relates to an equine cooling boot assembly useful for treatment of lameness, including laminitis and performance stress for equines. Specifically, it relates to a disposable cooling boot plus an orthotic pad, ankle bootlet, and sole plate assembly that are retained for reuse. Methods to apply cooling to an equine hoof and leg are also provided. Although designed for equine feet, it is easily modified to fit other four-legged animals, such as bovine, ovine, porcine, etc. by changing the size and shape of the boot.

### BACKGROUND OF THE DISCLOSURE

It is known that cold therapy (cryotherapy) is helpful in preventing injury in equines before and after stressful activity and in treating laminitis, especially in high performance horses. “It's called high performance for a reason, and the demands on the horses are high. On the international stage where therapeutic medication is not allowed to help with recovery or minor pain relief, icing is the primary way to maintain the horses' comfort and performance.” Jennifer M. Keeler, Ice Down To Ride On, The Chronicle of the Horse; Sep. 9, 2013, quoting Gill Merrick (see https://www.chronofhorse.com/article/ice-down-ride/). See also E. R. Hunt, Response of Twenty-seven Horses with Lower leg Injuries to Cold Spa Bath Hydrotherapy: Journal of Equine Veterinary Science; Volume 21, Number 4, 2001, p188-193.

Equine ice spas have therefore become popular and been shown to be very beneficial in preventing and treating injury. Ice spas are characterized by a reservoir of chilled coolant (almost universally water), usually containing sea salt and optionally magnesium salts, sometimes into which air is continuously injected for oxygenating the coolant and providing physical stimulation to the leg. Generally, the coolant is circulated through a refrigeration unit to maintain its low temperature.

Current commercial spas are large, expensive, immobile walk-in units. The large commercial spas also contain large volumes of water, which is typically recycled so as to maintain the salts. The horses are fitted with manure bags to aid in keeping the spa clean, but even so the the spa water must be filtered and chlorinated for recycling, which is expensive and marginally effective in removing fungi and other harmful contaminants.

In U.S. Ser. No. 18/597,177 (filed Mar. 6, 2024) we describe a water permeable fabric boot that was equipped with a sole plate to protect the fabric and had a soft gel orthotic insert inside to cushion the horse's hoof during use. While a tremendous advantage over walk-in ice spas and the prior art impermeable portable boots which wholly lacked support for the hoof, in practice we have found that sterilizing the fabric boot for the next usage to be somewhat cumbersome. Furthermore, boot manufacture was also somewhat difficult, contributing to cost and reducing our ability to provide boots in a range of sizes.

Thus, there is still a need in the art for portable ice spas or boots. The ideal portable ice boot would be light weight, portable, usable even where there is no electrical power, and have an orthotic hoof support, not available in any currently available systems. Furthermore, the boot would be easily cleaned for reuse or even have disposable components and not convey contaminants to the next horse. This invention meets one or more of those needs.

### SUMMARY OF THE INVENTION

Generally speaking, the invention is a portable ice boot that is configured to fit on an animal leg, such as a horse or other high-performance animal. The boot reservoir is a disposable, water impermeable bag that is fitted into a sole plate that protects the bottom of the boot from wear. Inside the bag is positioned a soft gel orthotic insert that cushions the animal's hoof. The top of the boot is preferably reinforced, and has attachment means for attachment to a separate harness that serves to hold the boot up and may optionally have means for closing the top of the boot around a leg.

Also, inside of the boot there is an internal ankle bootlet to both hold the orthotic insert and to firmly affix the boot around the ankle. The bootlet is reversible affixed to the sole plate with nylon rivets, screws, clips, or other fastening means. In preferred embodiments, the user may use their existing SOFTRIDE® boots rather than purchasing new bootlets, although the rivet holes may need to be added thereto. The use of existing bootlets reduces the overall cost of the system, and these bootlets are already available in five sizes, and we will make five sole plates to fit these five SOFTRIDE® boots. Our preferred attachment means is four two-part nylon ratchet/barbed rivets from Accu-Components, but other screws, snap-fits, and the like could be used.

The ankle bootlet, sole plate and orthotic insert are thus retained for reuse, but the reservoir itself is simple and cost effective enough to be disposable. If, however, the practitioner desires to reuse a reservoir bag, since its material is non-porous, it is easily sterilized by soaking in an appropriate solution.

Also, since the reservoir material is non-porous, rather than water permeable as in case Ser. No. 18/597,177, the reservoir is equipped with a one-way purge port midway up the reservoir. The ideal purge valve location is the mid carpel aka cannon bone. Below that level, the ice water slurry is retained, but water drains from above the drain/purge valve thereby lessening the weight on limb. Ice, however, is retained, and continually feeds the lower slurry zone for extended icing protocols with fewer interruptions for ice refilling. Uninterrupted icing sessions for at least 72 hours are desired.

Typically, the reservoir material is very flexible, and there is no real need for a slightly conical shape although that is certainly an option. Thus, we have used SEAL LINE GEAR® clear dry bags (BAJA VIEW™ dry bags), which are available in a variety of sizes and are already equipped with a one-way valve. These bags are made of transparent 12 oz thermoplastic polyurethane film and are modified for use herein by adding a reinforcement strip to the top and attachment means for attachment to the harness. There are many similar bags on the market that may be used.

In our prototypes, we glued two rubber reinforcement strips to the top of the bag separated by 1-3 inches, the upper reinforcement strip was equipped with rings for attachment to the lockable hooks or other fastener of a separate harness. The lower reinforcement strip was fitted with a drawstring for pulling the top of the reservoir closed around a horse's leg, although the relative positions of these two reinforcement straps could be reversed.

The invention includes any embodiment(s) herein described, in any combination(s) thereof.
An ice boot reservoir for use with an ice boot assembly, said reservoir sized and shaped to fit over a leg of an animal and comprising: a) a flexible generally cylindrical bag having an open top and a closed bottom for containing a coolant; b) said bag having a reinforced upper rim near a top of said bag; c) said reinforced rim having attachment means for attaching to a separate harness; d) a one-way water valve midway along said bag to allow excess water to drain out of said reservoir.
An ice boot assembly, comprising: a) any reservoir herein described; b) a sole plate having a base and side walls completely circumnavigating said base; c) an ankle bootlet having a solid base and a flexible upper configured to close over said animal's ankle when in use; d) wherein said ankle bootlet is positioned inside a bottom end of said reservoir and said reservoir is positioned inside said sole plate; e) wherein said sole plate is reversibly attached to said solid base of said ankle bootlet through said reservoir.
An ice boot assembly, comprising: a) any reservoir herein described; b) a sole plate having a base and side walls completely circumnavigating said base; c) an ankle bootlet having a solid base and a flexible upper configured to close over said animal's ankle when in use; d) an orthotic insert configured to cushion said animal's foot when in use; e) said orthotic insert reversibly attached to a bottommost inside surface of ankle bootlet; f) said ankle bootlet positioned against an inner bottommost surface of said reservoir; g) said reservoir positioned inside said sole plate; and h) said sole plate reversibly connected through said reservoir to said solid base of said ankle bootlet.
A method of treatment with cryotherapy treatment, comprising fitting a leg of an animal that will benefit from cryotherapy treatment into any ice boot assembly herein described while said bag is crushed down to said sole plate, closing said ankle bootlet over an ankle of said animal, lifting said bag, attaching said attachment means to a separate harness on said animal, and filling said ice boot of with coolant comprising ice and optionally salt for time sufficient to cool said leg.

Any reservoir herein described, said bag comprising a polyurethane film or a transparent polyurethane film or a 12 oz transparent polyurethane film.

Any reservoir herein described, said bag also having a drawstring near a top of said bag for closing said bag around a leg.

Any reservoir herein described, said bag further comprising a one-way air hose connecter near a bottom of said bag to allow air to be pumped up through said bag.

Any assembly herein described, said ankle bootlet further having an orthotic insert therein for cushioning an animal's foot. Preferably, the orthotic insert is reversibly attached to an inner bottom surface of said ankle bootlet. Even more preferred, the insert is an inflatable orthotic connected to a pump for cyclic addition and removal of air or fluid to the orthotic.

Any assembly herein described, said orthotic insert comprising a polyurethane gel having a Shore A hardness of from about 0 to about 50.

Any assembly herein described, said orthotic insert comprising a polyurethane gel having a Shore A hardness of from about 0 to about 50 and having grooves in an upper surface thereof. Preferably, the plurality of grooves are at a plurality of angles in an upper surface thereof.

Any method herein described wherein air is bubbled up through the bag during treatment, thereby massaging the leg.

Any method herein described wherein air is cyclically added to an inflatable orthotic, thus cyclically loading the frog.

As used herein, Nylon is a family of synthetic polymers with amide backbones, usually linking aliphatic or semi-aromatic groups.

As used herein, Velcro is any hook-and-loop fabric allowing reversible connection of any parts the Velcro patch is affixed to. At least 2 patches are needed, one with hooks and the other with loops, but an even stronger connection is possible with three pieces, the centerpiece being double sides, so the other two pieces bracket the center piece.

As used herein, any fastening means to attach two materials together (e.g., reservoir to reinforcement and attachment means) can be used, provided suitable for the materials and shapes in use. These, include e.g., heat welding, laser welding, RF welding, pressure welding, chemical bonding, glues, and adhesives, embedding in resin, dipping in resin, sewing, and the like, plus combinations thereof. Where reversible attachments are needed, Velcro is preferred. For permanent attachment, glue and/or sewing are preferred.

The attachment means for the harness to boot connection are preferably, but not necessarily, reversable. These include hooks and holes, rings or other hooks, clips, pins, Velcro, snap-fit connectors such as buckles and the like. Preferred means are lockable hooks so that the hooks are not easily dislodged.

As used herein, the reversible attachment means for attaching the sole plate to bootlet can be e.g., screws, nuts and bolts, rivets, barbed rivets, snap-fit connectors, etc.

As used herein, “generally cylindrical” allows the top end to be slightly larger than the bottom, for compact collection of the walls, whereas cylindrical is the same size throughout the length. The walls can be “slightly conical”—being larger at the top, or they may be stepped—the upper portion larger than the bottom. A conical shape is preferred, with the top being 1-2 inches larger than bottom, a greater increase in size needed for a longer boot. All that is needed, is enough spread to allow the walls to be collected at the base and allow easy ingress to the inner bottom surface of the boot. For many dry bags, the bag itself is sufficiently flexible, that a straight cylinder will suffice.

As used herein, being “near” the top or bottom means 0-3 inches from the top or bottom edge.

### DESCRIPTION OF THE FIGURES

The FIGURES represent embodiments and aspects of the invention and are not intended to be limiting of the scope of the invention.

FIG. 1 is a perspective of a sole plate alone, but pictured with barbed rivets which snap fit together.

FIG. 2 shows the reservoir alone with reinforcement strip near the top, drawstring strip thereunder, one way water port midway and optional air hose connector near the base of the bag.

FIG. 3A shows ankle bootlet from the side with a solid base and fabric and Velcro upper fitted into the solid base and configured to close around an ankle.

FIG. 3B shows the ankle bootlet from the back.

FIG. 4A-D show four varying embodiments of an orthotic insert.

FIG. 5A shows the various components from FIG. 1-4 unassembled, but placed in order.

FIG. 5B shows parts from FIG. 1-4 assembled and in cross section.

FIG. 5C is a perspective view of the assembled ice boot of FIG. 5B.

FIG. 6 is one embodiment of an ice boot support or harness system.

### DETAILED DESCRIPTION

The present invention is an ice boot assembly and system for cooling the legs of equine and other four-legged animals. The boot assembly (spa) consists of a disposable reservoir for containing coolant inside a solid sole plate. The reservoir is preferably clear and has one or more reinforcement strips along the top having attachment means for suspending the boot from a separate harness.

The reservoir is preferably equipped with a midway one-way valve or port that allows fluid to drain from the upper part of the bag. There may also be means for injecting air or other gas into the bottom of the reservoir, thus providing a massaging action as air bubbles upwards. A gathering strip or buckled straps near the upper end may be used to close the reservoir against the leg, but this feature is optional.

Inside the reservoir at the base is positioned an ankle bootlet. The bootlet can be closed around the animal's ankle and is also attached through the reservoir to the sole plate with any suitable attachment means. A shock adsorbing elastomeric and/or inflatable pad is disposed in the bottom of the bootlet.

The position and number of fasteners for reversibly attaching the bootlet, reservoir and sole plate together can vary and be on the side, the bottom, or both. We used 4 barbed rivets through the side of the bootlet, each meeting its mating rivet through the side of the sole plate. Thus, the reservoir has been perforated at these 4 points. However, our tests show leakage is de minimus.

Prototype boots have a height of about 18 to 24 inches with about 20 inches preferred and a bottom diameter of about 6-7 inches and top diameter of about 8-12 inches. These dimensions are illustrative only and may vary as desired. Boots for donkeys and ponies will be smaller than boots for Arabs and Quarter horse, which in turn will be smaller than boots for draft horses. Shape may also vary depending on hoof shape, and with the animal being treated.

Since manufacture of this boot is easy, we have prepared sole plates in five sizes to fit the five sizes of the SOFTRIDE® boots that we are using as the ankle bootlet, by merely providing holes in the solid base for the rivets or other fasteners. The bags may likewise be provided in these five sizes.

Reservoir water can continually seep out via the one-way valve midway, coating the outside of the lower reservoir with water. The continual draining of water along the outer surface allows evaporative cooling and provides insulation to help slow the melting of the ice. It also reduces the weight of the water, as water in the top drains out, but ice is retained to continually feed the lower end.

One advantage of the flexible reservoir bag design is that the ice reservoir of the boot may be folded down, so the walls are bunched at the bottom of the boot, which allows the equine leg to be easily fitted thereinto. In use, the walls are rolled down and bootlet and the orthotic insert added and attached (unless already present). The orthotic insert can be simply placed inside the bootlet, since it is fully contained, but if desired it can also be attached thereto with a Velcro patch, or any other reversible attachment means could be used. This is preferred with most bootlets, since the boot is fairly round, and the insert can otherwise rotate.

The horse's or other animal's foot is placed thereinto, and the bootlet closed around the ankle. The walls of the reservoir are then lifted up and secured to a harness on the horse. Coolant is then added to the ice boot reservoir, and if present, the top of the reservoir may be tightened via gathered string or latched straps to keep ice well contained.

If air is to be bubbled though the ice boot, a hose is connected to the boot via a suitable port near the bottom and an air source (pump) and run, thus also providing a massage effect while in use. An air pump such as those available for hydroponics and weighing about 4-8 pounds works well. The air pump is preferably battery operated and/or fitted with a connection for an external power source. In one aspect, the air pump will have four air outlets to accommodate spas on four hooves. It will be housed in a watertight housing and adapted to be hung onto an equine withers with a strap or harness such as a surcingle.

If air is to be cyclically added to the orthotic, it too is connected to a pump for cyclic inflation and deflation of the orthotic. This may be the same pump, and air being cyclic in both instances or separate pumps may be used. As a preferred alterative, the same pump may be bifurcated for constant and cyclic air delivery.

Coolant may be as simple as crushed ice in water, which in the open top boot will be very suitable and is preferred. Other coolants may also be used, particularly if the coolant is externally cooled and circulated in the coolant bag or boot. Suitable coolants should have good thermal conductivity, a low flash (or vaporization temperature) point, be non-corrosive, inexpensive and readily available and be able to dissolve sea salt and/or magnesium salts. Some useful coolants include, but are not limited to chilled water, ethylene glycol, propylene glycol, methanol/water, ethanol/water, calcium chloride solution, potassium formate/acetate solution. The choice of coolant can also be made to affect the temperature of the coolant. Temperatures to which the hoof can be cooled are not extreme—e.g. it is unlikely that the temperatures below about 0° C. will be desirable and then only if the coolant is not in direct contact with the skin. Generally, coolants will be above about 32° F. (0° C.).

Water with ice is the preferred coolant since the spa is intended to be portable and ice is readily available and inexpensive. A refrigerant means for chilling and circulation coolant is acceptable and within the scope of the invention, but less portable, more expensive and requires an external source of electric power. Ice and water require no electric power and allows greater portability for the apparatus.

The ice boot also has an exterior sole plate that is typically resin, and that functions to protect the reservoir from wear and tear. This is made separately and attached through the reservoir to the bootlet with any suitable fastening means, herein two pronged barbed rivets. Suitable and effective sole plates are described in more detail in U.S. Pat. No. 8,220,231, US201100673661, USD565256 and USD616614, and the optional rocker attachment as described in US20110067366.

The sole plate is desirably sloped front to back on the bottom surface or has a rocker surface (convex) to provide an easy break-over as is described in the patents and applications disclosed herein. The sloped sole allows a rolling or rocking motion of the sole to eliminate tearing and trauma of a horse moving or turning. It relieves stress on the deep digital flexor tendon. This can be especially important because of the extra weight of the water filled boot.

The sole plate also contains the bootlet in position inside the sole plate (and inside the reservoir). It is thus walled around the entire circumference and is 0.5-2″ or about 1 inch deep. In preferred embodiments, the sole plate is specifically configured to perfectly fit over our SOFTRIDE® boots.

The soft orthotic pads should generally extend to the edges of the inside walls of the bootlet and generally reflect the shape of the animal's foot. For example, Arabian horses generally have more elongated hooves than Quarter horses. It has also been found that the shape of the pad is important for its therapeutic efficacy, rocker pads and sloped pads being useful for certain conditions. Moreover, more elongated oval shapes are especially useful in laminitis affected horses, where the hoof is tilted downward because of the abnormal growth rates of the hoof walls caused by the compromised tubules of the laminae. Pads (and sole plates) with a relatively wide heel section allow better rocker action and better flow of coolant around the hoof. As mentioned, we have five sizes of SOFTRIDE® boot, and have a variety of inserts designed to fit inside these boots.

The orthotic pad may be made of any suitable shock absorbing material such as elastomeric polymer material that provides flexibility, shock absorbency, some degree of elasticity, resilience and has dimensional stability. Polyvinyl chloride (PVC), polysilicon and similar elastomers are suitable. In a preferred embodiment, the pad is constructed of a cast polyurethane elastomer. For example, polyurethane-casting elastomer having a Shore A hardness of from about 0 to about 50 is acceptable.

In most cases it is desirable that the orthotic pad be a relatively soft and deep elastomer, Shore 00 of 5 to 60, and of about 0.50 to 2.0 inches thickness. This deep soft pad is especially useful where the hoof is damaged or diseased. The soft pad will conform to the shape of the hoof and reshape itself as the horse shifts its weight since the pad is soft and pliable and constrained by the wall of the boot, e.g. the sole plate wall providing not only good support but a massaging action.

The orthotic pads may be single density or dual density. In a dual density pad the front and rear section will have Shore 00 hardness between 5 and 70 but will be different front and rear. For example, a dual density pad may have a front section of Shore 00 hardness of 30 and a rear section hardness of 60 Shore 00. Or, conversely, it may have a front section hardness of 50 and a rear section hardness of 20 Shore 00. Suitable single and dual density pads are described and illustrated in U.S. Pat. Nos. 7,445,051, 8,220,231, USD616614 and USD29/454,564.

The choice of hardness and the arrangement in the dual density orthotic pad is determined by the desired outcome. For example, if it is desirable to have the hoof tip or lean forward then a softer front section would be indicated. The principal importance of the soft deep pad is that it lets the horse seek the most comfortable position for the hoof and thus minimize stress and damage. Moreover, it provides additional rocker effect—the hoof can rock back and forth in the soft pad material—to allow the horse to achieve more natural balance. Coupled with a cooling boot, the deep soft pad provides has been found to be especially efficacious for treating horses with laminitis.

As noted above, the pad may also be inflatable, in which case, the grooves etc. may be omitted. Even though inflatable, an elastomeric material for the orthotic is still desirable, and the walls should be thick enough to resist bursting with the 700-1200 pound weight for a regular horse, and up to 2000 pounds for a draft horse. Thus, we anticipate that the pad walls will be at least 3 mm thick, and more likely 5-8 mm or even 1 cm.

The orthotic pad may be mounted inside the bootlet at its base with or without any fastening means. Where a fastening means is used, removable fastening means are preferred, typically Velcro. When the mating hook-and-loop (Velcro) straps are connected, it prevents the pad from rotating in the bootlet during use. The hook-and-loop straps may be sewn to the bootlet fabric or attached by adhesive, or both. Attachment of a hook-and-loop strap piece and the appropriate sizes are described U.S. Pat. No. 8,220,231 and US20110279184.

Alternatively, the bootlet shape can be asymmetrical (e.g. oval or having a tab at the toe, etc.), and thereby prevent rotation of the orthotic insert, or both asymmetry and Velcro may be used. Other attachment means include screws, bolts, rivets, washers, glue, snap fit components (assuming the orthotic pad has a hard base that can be molded for snap fit), or any other attachment means discussed herein.

The ice boot assembly and method can be used on shod and unshod horses. It will be an advantage in some circumstances to have the hoof shod, all things being equal, since the shoe will allow coolant to contact the sole of the hoof as well as the wall. Plastic or polymer, light weight shoes that can be attached to the hoof without nails (as with an adhesive) may be preferred.

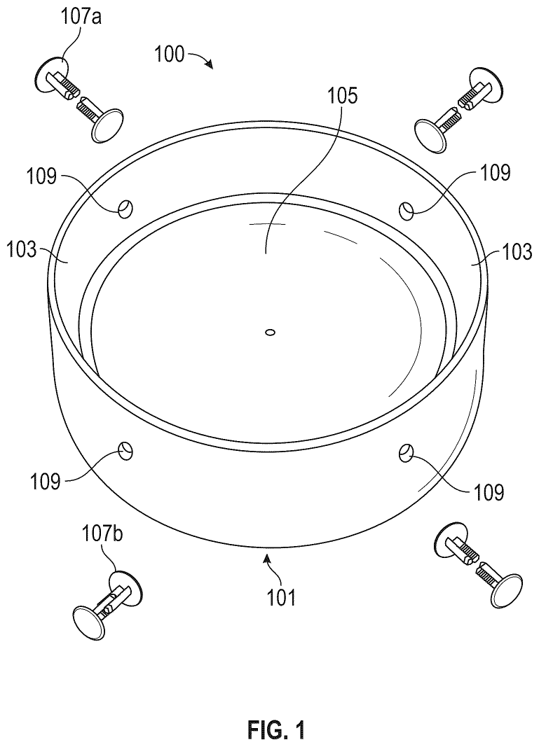

Referring to FIG. 1 we see a prototype sole plate that is generally oval but may vary to fit specific animals or bootlets. The sole plate 100 has a base 101, and side walls 103 circumnavigating the entire base 101. Inner surface of base 105 is shown with two pong barbed rivets 107a, also shown connected 107b that are inserted at holes 109.

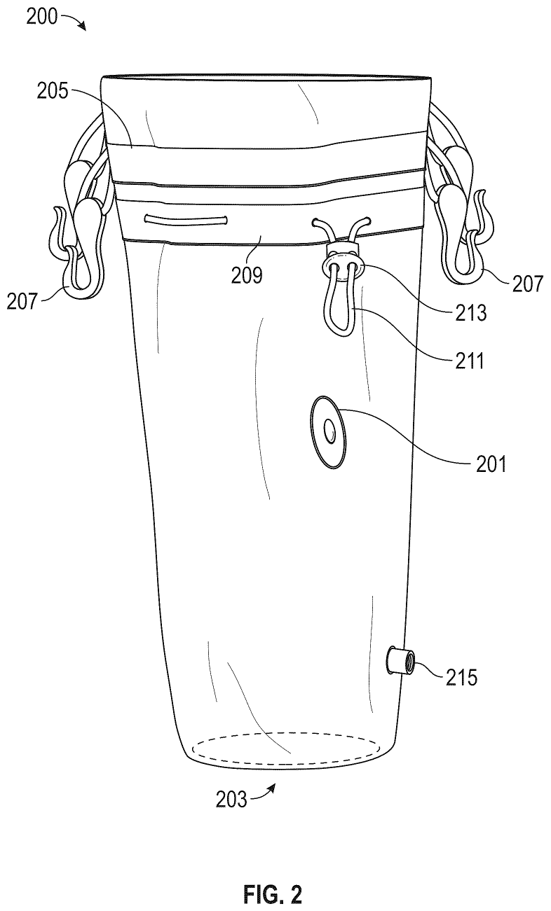

In FIG. 2 we see the reservoir bag 200 alone, not with sole plate or any interior components. The bag has an open top and closed bottom and is cylindrical in shape. A one-way fluid port 201 is shown midway along the bag, with an optional circular solid base 203 glued or welded thereto. We have added top reinforcement strip 205 with loops and hooks 207 (X4), a second gathering strip 209 with drawstring 211 and spring lock 213. Also seen is 215 a one-way air hose connector.

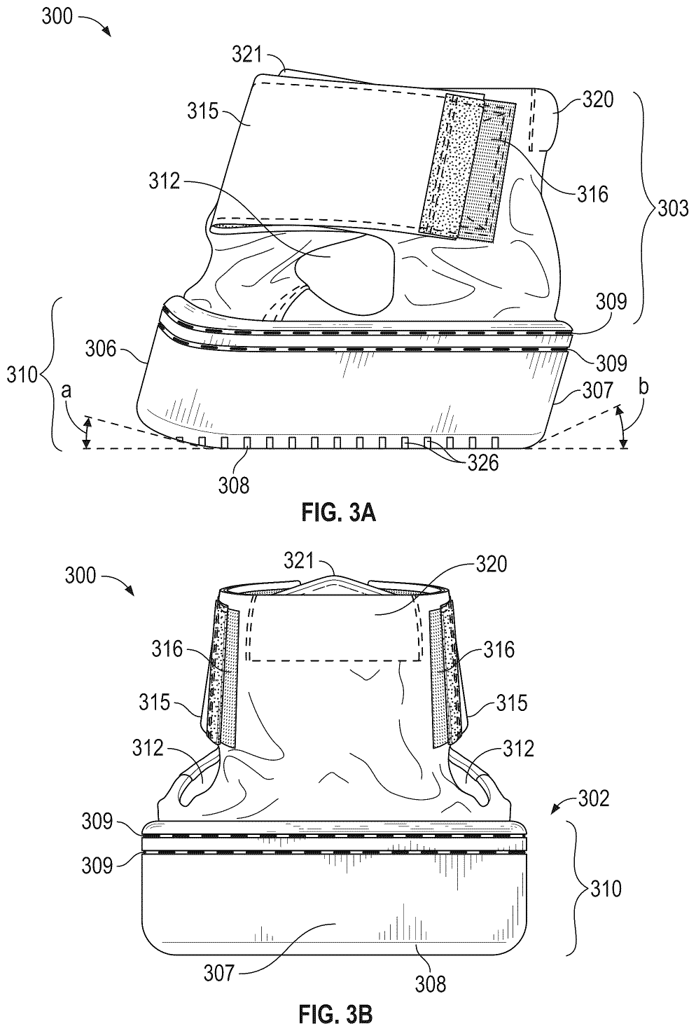

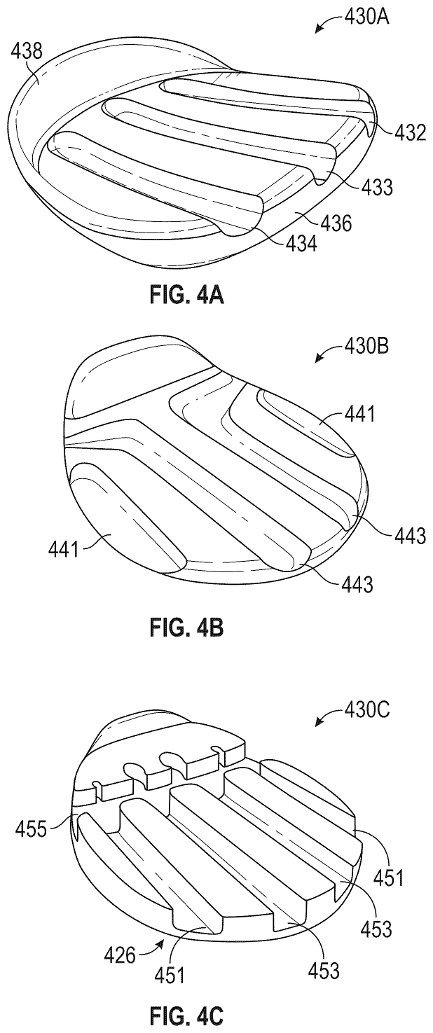

In FIG. 3A-B we see one example of an ankle bootlet, as described in US2007107389 et seq. The bootlet 300 consists of a flexible upper body 303 attached inside a hard solid sole plate 310. Double rows of stitching 309 and/or adhesive or both connect the base 310 to the upper 303.

The solid base 310 in the bootlet of FIG. 3A-B is a separate molded piece and is attached to the bottom of the fabric upper 303. The base consists of a bottom plate 308 and walls or sides 306/307 that extend upward from an exterior edge of the bottom plate 308, similar to the sole plate. The bottom 308 is preferably about 0.375 inches to 0.65 inches thick, but may be from 0.2 to 0.75 inches in thickness. The base walls 306/307 will extend upward 1.5 to 2.25 inches at the rear wall 307 and 1.75 to 3 inches at the front wall 306, as measured from the bottom of the sole plate surface. 326 are friction grooves on the undersurface of the base 310 and angles a and b (5-20°) allow easier break-over of the hoof.

The base is preferably molded of polymeric elastomer material or hard rubber (having the consistency and hardness to approximate automobile tires). Thermoplastic polyurethanes (TPUs) are suitable materials for the base plate. It is preferred that thermoplastic polyurethanes of about 55 to 75 Shore A hardness be used, with Shore A hardness of 65 to 70 being especially suitable. Other polymer materials of the same characteristics the thermoplastic polyurethanes are also usable. Choice of these will be well within the ability of those skilled in the polymer art to select. Other details for the bootlet can be found in U.S. Pat. No. 8,220,231, US2009032270 and USD565256, USD616614, each incorporated by reference in its entirety for all purposes.

The body 303 has side openings 312 and closure straps 315-316 and the size and shape of the body will vary according to animal on which it will be used. Generally, for horses, the bootlet will be sized to accommodate a four (4) to nine (9) inch diameter pad, about four (4) to ten (10) inches from front to rear. The height from sole to the top will be sufficient to clear the hoof so the bootlet top may be secured around the leg above the coronary band and the bulbs of the heel of the animal. The boots are from about three (3) to eight (8) inches in height. In one embodiment the rear side of the bootlet will be 4.5 to six (6) inches from the top to the bottom of the sole plate with the front side slightly longer (to account for the slope of the front side).

There are openings or holes 312 along the side of the bootlet to allow it to be opened for placing on the animal's foot and can also pass a hose for an inflatable orthotic. The distance of the openings from the sole will be sufficient to cover shock-absorbing the pad and the length of the slit will be sufficient to allow the boot to be opened to easily slip onto the hoof. For horse bootlets, the opening on the sides will ideally start about two (2) to three (3) inches from the sole and be about three (3) to five (5) inches in width.

The top of the bootlet is enclosed around the ankle by fastening means. Suitable attaching means can consist of straps, illustrated by 315 and 316 of FIGS. 3A-B, that operate by connecting the straps 315 and 316 so that the opening fits snugly around the foot of the animal. The straps consist of a first set attached to the rear top of the boot that are attachable to a second set of straps attached to the front top side of the boot by any convenient means. The attachment overlaps the front straps over the rear straps to secure the rear strap top and bottom. This gives a secure and reliable closure. A suitable fastening means is a strap attached to the front having attached to both sides one half of a hook-and-loop connector (for example, Velcro) and a strap attached on the rear having connected to both sides thereto the other half of a hook-and-loop connector. The strap is from about one half to three (3) inches in length. The straps may also be buttoned, snapped, or tied, but preferable are hook-and-loop patches.

The boot is made of any suitable flexible material, such as leather, woven or non-woven fabric. It has been found desirable to use a double layer of fabric, but this is not essential. A particularly suitable fabric is an 18 oz. Ballistic cloth used by the U.S. military for bags. A DuPont nylon woven fabric, CORDURA® available in several weights, may be used. The 330 denier fabric is preferred. Other tough fabrics include any ripstop nylon, high density polyethylene, DYNEEMA®, DYNEEMA® composites, KEVLAR®, SILNYLON®, and the like.

In one embodiment there is a strip of hook-and-loop fastener attached to the top side of the bottom fabric of the upper fabric bootlet. This strip is positioned to mate with a matching strip of hook-and-loop fastener on the bottom side of the orthotic pad. When assembled the two sides of the hook and loop fasteners connect to secure the pad to the bottom of the fabric boot to prevent rotation of the pad during use. The hoof of a horse on which the boot is fitted exerts tremendous pressure and turning torque on the pad. The hook and loop attachment prevents the pad from rotating. The patches are from 0.5 to four (4) inches in length and from 0.5 to 2.5 inches in width.

It is preferred, that the front and rear tops of the bootlet at points 320 and 321 in FIGS. 3A-B be padded. The padding is constructed by enclosing a polymeric foam, closed cell rubber pad, or other suitable resilient material, inside a pouch of the fabric at the top and rear of the boot. A round section of polymer foam padding is very suitable. Such padding may be the kind used in door insulation or expansion joints for concrete driveways or sidewalks. Any polymer foam is suitable as is cotton or synthetic fiber padding. This padding allows a closer and more secure fit around the animal's leg. The rear pad should be above the bulbs of the hoof so that the boot does not rotate. A round foam pad of about 1 inch in diameter is generally ideal. Padding of 0.5 to about 1.5 inches is desired.

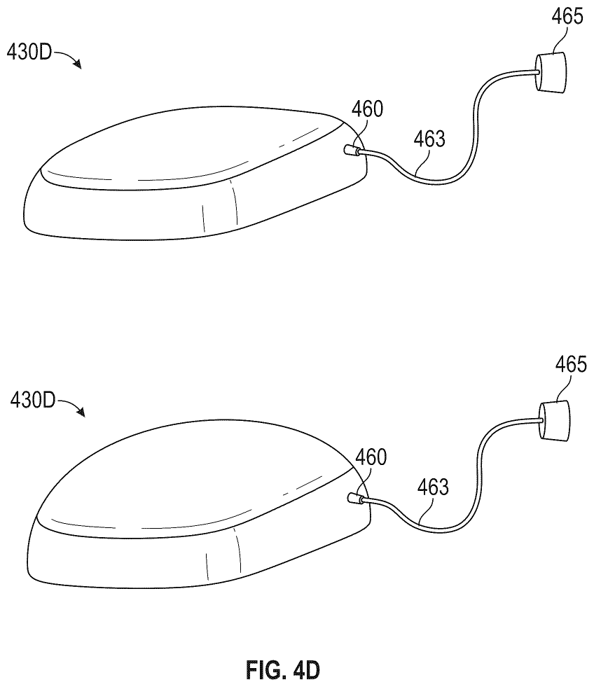

FIG. 4A-C shows an orthotic insert for use with the ice boot assembly. The orthotic pad 430A has linear grooves 432, 433 and 434 on the upper surface of the pad base 436 that will allow ice water to flow through the grooves beneath the hoof. Pad 430B has edge grooves 441 and L-shaped grooves 443, and pad 430C has edge grooves 451, center grooves 453 and a cross groove 455. In preferred embodiments, these grooves are both vertical and horizontal, allowing front to back and side to side movement of the ice water. As the horse shifts its weight the ridges compress and expand (but are circumferentially constrained by the side walls of the sole plate) to provide a pumping action to move the coolant beneath the hoof and to help prevent stagnant warn spots of coolant.

The orthotic pads 430A-C also has a raised front 438 to provide a comfortable cushioned stop for the toe of the hoof. The bottom or under surface 426 of base 436 may have a Velcro patch (not seen herein, but typically just a square or rectangle adhered to the underside) to mate with Velcro patch on the inside of the bootlet.

In one embodiment, the orthotic is a hollow disk that can be cyclically filled with air, thus allowing the foot to be subject to the same natural loading pressures that occur when a horse walks. If desired, this can be connected to the same air pump as cyclic pulsing of the leg is still suitable, or a separate air pump may be provided one providing cyclic air, and the other steady air. As yet another alterative, the same pump may be bifurcated for air delivery, one line providing constant air and the other cyclic air in which case the bag is fitted with two air valves. Adding a pressure switch, timer, a solenoid fill valve, and a solenoid dump valve will allow cyclic inflation. When the pressure reaches a desired psig, the pressure switch closes the fill valve and starts the timer. After two seconds the timer opens the dump valve and pressure is released. It may even be possible to route the purge air through the bag, thus providing the massage function.

This embodiment is shown in FIG. 4D where we see a relatively smooth disc 430D with valve 460 connected to hose 463 connected to pump 465. When inflated, the center of the pad will lift up. As pressure is thereby applied to the frog, the digital cushion is compressed under the short pastern, navicular, and coffin bone. The vascular cartilage of the cushion is compacted, forcing blood flow proximally back up the limb of the horse. The inflatable orthotic thereby stimulates blood flow as well as causing the hoof itself to expand and contract.

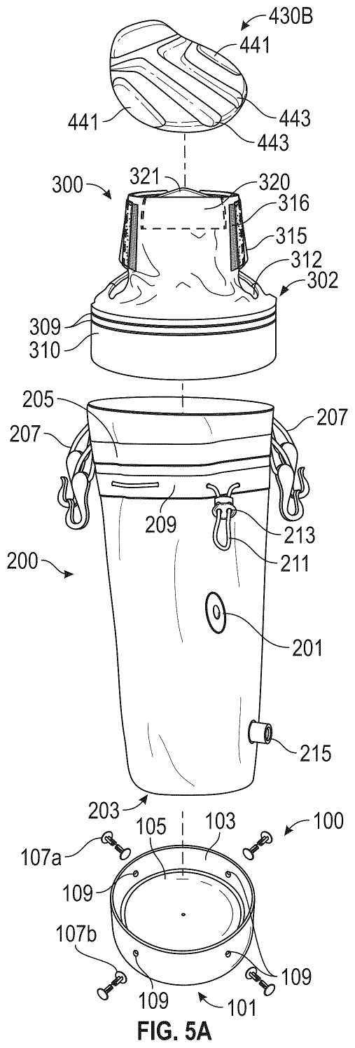

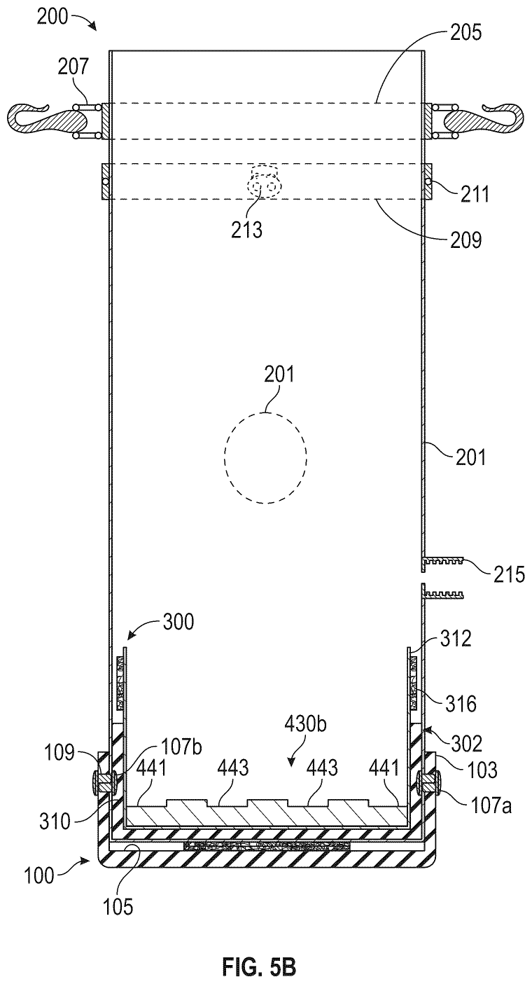

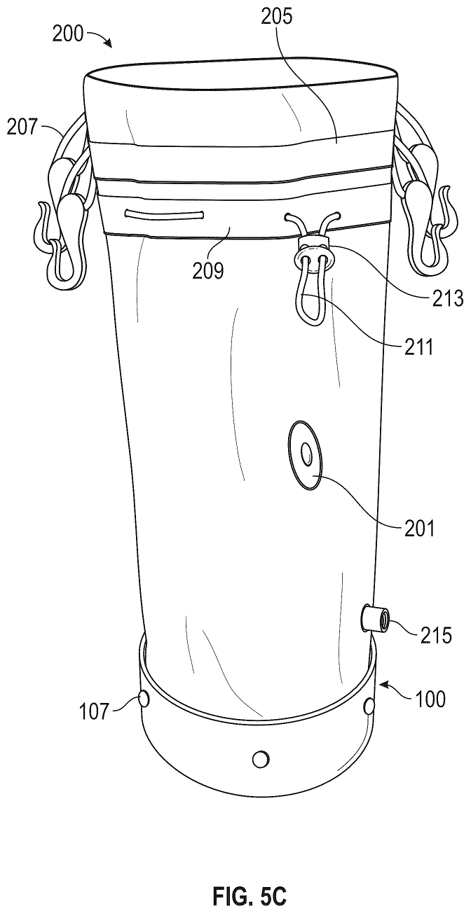

FIG. 5A shows the components of the system in an unassembled state but arranged in order. Thus pad 430 fits into boot 300 which fits into reservoir 200 which fits into sole plate 100. FIG. 5B shows them assembled in cross section and FIG. 5C shows a perspective view of the components assembled.

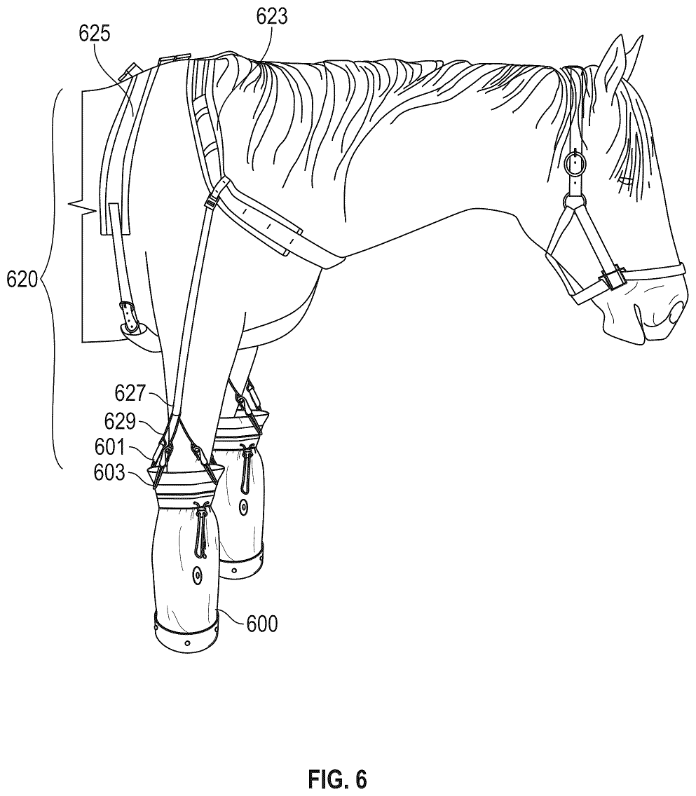

The harness need not be specifically made for this use herein. Thus, an over-girth or surcingle or any existing neck, shoulder or wither collar can be used by adding ice boot suspension straps. A preferred design for the boot straps has four attachment points (only 3 visible in FIG. 6 as the 4^{th} is behind the leg) which helps keep the upper section of the ice boot assembly centered, enabling feeder ice to be easily added. Generally, the inner straps are longer than the other straps as they have farther to travel to the inside of the legs. This design helps keep the boot centered with a horizontal rim so the cooling ice slurry cold therapy can be uniformity applied to the entire distal limb. Just using 1 or 2 attachment points would allow the rim to tip, dumping water. Thus, 3 or 4 attachments are preferred.

An example of a shoulder harness of this type is shown in FIG. 6, wherein the ice boot assembly 600 is equipped with loops 603 and hooks 601 that connect via straps and hooks to a harness. Harness 620 can be any harness, but here shown harness 620 has a neck strap 623 and girth strap 625 for securing to the horse. Hanging from neck strap 623 are boot straps 627 ending in elastic straps 629 that are caught by hooks 601. These boot straps can be added to any existing harness, or a specialty device with all components can be designed and sold. While hooks and loops are shown herein, any reversable attachment means could be used, such as two hooks, hook and ring or hole, clips, etc.

To fit the equine leg into the ice boot assembly, the sides of the flexible reservoir with bootlet and orthotic pad already inside the reservoir and affixed to sole plate are pushed down to bunch at the bottom of the assembly. Then the leg is guided into the bootlet and the bootlet is closed around the ankle. The reservoir bag is then pulled up and attached to the boot straps on the harness. Once hung, it is filled with coolant, and if available one or two air pumps are connected to the lower air hose port or ports and also hung from the harness.

Optionally, sea salt is added to the coolant in the reservoir and optionally magnesium salt. Sea salts contain a number of elements other than sodium chloride that are beneficial in the spa treatment including potassium, calcium chloride and bromides. Moreover, the source of sea salt is important in selection of trace minerals. For example, it is reported that waters from the Dead Sea are unique in that they contain 27% of various salts as compared to 3% in normal sea water. Further, while sodium accounts for approximately 80% of the salt content of normal sea water, it comprises much less of the salt total in water from the Dead Sea. The balance of the salts in Dead Sea water is magnesium, potassium, calcium chloride, and bromides. Sea salts from various sources and with varying amounts of minerals are available commercially. Magnesium salts that are soluble in water are also available. Magnesium sulfate and magnesium chloride are useful. As with sea salts magnesium salts from different natural sources are available.

In general, it is desirable that the salt concentration be about twice that of sea water. A concentration of about 0.2 pounds of sea salt and 0.3 pounds of magnesium salt has been shown to be effective. Since the effectiveness of the osmotic effect of the minerals is determined by concentration (and temperature) optimum salt levels may be determined by simple experimentation. It is reported that concentration of 2 and 7.5% sea salt in water is very effective in reducing pain and increasing mobility in human trials. Machtey, Dr. I. 1982, Dead Sea Balneotherapy in Osteoarthritis, Proc. International Seminar on Treatment of Rheumatic Diseases. It is assumed that the same is true of equine legs. The salts may be prepackaged in the correct amount to add to a predetermined amount of water in the boot reservoir. Coolant temperatures of about 32-40° F. are desirable. Treatments (legs in coolant) of about 20-40 minutes have been found effective.

A short prototype of the boot assembly will contain about 2.25 gallons of coolant with an equine leg in the boot. A taller prototype holds about five (5) gallons. A suitable method of filling the boot is to fill the bottom of the boot to above the ankle (about one gallon in the prototypes) add salt and mix. Then add ice to fill the boot. Adding water first keeps the ice from lodging under the hooves (ice floats) and allows better mixing and dissolution of the salts.

In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

Each of the following are incorporated by reference in its entirety for all purposes.

U.S. Pat. No. 10,375,946 US2017290317 Reduced weight equine orthotic pad and method.

US2015119772 Equine exercise boot assembly and ice spa.

US2017280682 Equine exercise boot assembly and ice spa.

U.S. Pat. No. 8,166,734 US2010095641 Equine cold therapy apparatus and method.

U.S. Pat. No. 8,220,231 US2009032270 Equine boot.

U.S. Pat. No. 8,291,683 Equine exercise boot assembly and method.

U.S. Pat. No. 9,055,732 US2015156989 Equine ice boot.

USD565256 Equine boot.

USD616614 Equine boot.

USD709656 Equine boot orthotic pad.

USD743637 Equine ice boot.

USD746519 Equine boot ridged orthotic pad.

USD831900 Equine boot orthotic pad.

USD831903 Equine boot orthotic pad with frog support.

WO2006025864 Slip-on animal hoof boot assembly.

1. An ice boot reservoir for use with an ice boot assembly, said reservoir sized and shaped to fit over a leg of an animal and comprising:
a) a flexible cylindrical bag having an open top and a closed bottom for containing a coolant;
b) said bag having a reinforced upper rim near a top of said bag;
c) said reinforced rim having attachment means for attaching to a separate harness;
d) a one-way water valve midway along said bag to allow excess water to drain out of said reservoir.

2. The reservoir of claim 1, said bag comprising a polyurethane film.

3. The reservoir of claim 1, said bag comprising a transparent polyurethane film.

4. The reservoir of claim 1, said bag comprising a 12 oz transparent polyurethane film.

5. The reservoir of claim 1, said bag having a drawstring near a top of said bag for closing said bag around a leg.

6. The reservoir of claim 1, said bag further comprising a one-way air hose connecter near a bottom of said bag to allow air to be pumped up through said bag.

7. An ice boot assembly, comprising:
a) the reservoir of claim 1;
b) a sole plate having a base and side walls completely circumnavigating said base;
c) an ankle bootlet having a solid base and a flexible upper body configured to close over said animal's ankle when in use;
d) wherein said ankle bootlet is positioned inside a bottom end of said reservoir and said reservoir is positioned inside said sole plate;
e) wherein said sole plate is reversibly attached to said solid base of said ankle bootlet through said reservoir.

8. The assembly of claim 7, said ankle bootlet further having an orthotic insert therein for cushioning an animal's foot.

9. The assembly of claim 7, said ankle bootlet further having an inflatable orthotic insert therein fluidly coupled to an air pump for providing cyclic pressure to said animal foot.

10. The assembly of claim 8, said orthotic insert comprising a polyurethane gel having a Shore A hardness of from about 0 to about 50.

11. The assembly of claims 8, said orthotic insert comprising a polyurethane gel having a Shore A hardness of from about 0 to about 50 and having grooves in an upper surface thereof.

12. The assembly of claims 8, said orthotic insert comprising a polyurethane gel having a Shore A hardness of from about 0 to about 50 and having a plurality of grooves at a plurality of angles in an upper surface thereof.

13. An ice boot assembly, comprising:
a) the reservoir of claim 1;
b) a sole plate having a base and side walls completely circumnavigating said base;
c) an ankle bootlet having a solid base and a flexible upper body configured to close over said animal's ankle when in use;
d) an orthotic insert configured to cushion said animal's foot when in use;
e) said orthotic insert reversibly attached to a bottommost inside surface of ankle bootlet;
f) said ankle bootlet positioned against an inner bottommost surface of said reservoir;
g) said reservoir positioned inside said sole plate; and
h) said sole plate reversibly connected through said reservoir to said solid base of said ankle bootlet.

14. The assembly of claim 13, said orthotic insert being an inflatable orthotic insert fluidly coupled to an air pump for providing cyclic pressure to said animal foot.

15. The assembly of claim 13, said orthotic insert comprising a polyurethane gel having a Shore A hardness of from about 0 to about 50.

16. The assembly of claim 13, said orthotic insert comprising a polyurethane gel having a Shore A hardness of from about 0 to about 50 and having grooves in an upper surface thereof.

17. The assembly of claim 13, said orthotic insert comprising a polyurethane gel having a Shore A hardness of from about 0 to about 50 and having a plurality of grooves at a plurality of angles in an upper surface thereof.

18. A method of treatment with cryotherapy treatment, comprising fitting a leg of an animal that will benefit from cryotherapy treatment into the ice boot assembly of claim 7 while said bag is crushed down to said sole plate, closing said ankle bootlet over an ankle of said animal, lifting said bag, attaching said attachment means to a separate harness on said animal, and filling said ice boot with coolant comprising ice and optionally salt for a time sufficient to cool said leg.

19. A method of treatment with cryotherapy treatment, comprising fitting a leg of an animal that will benefit from cryotherapy treatment into the ice boot assembly of claim 9 while said bag is crushed down to said sole plate, closing said ankle bootlet over an ankle of said animal, lifting said bag, attaching said attachment means to a separate harness on said animal, connecting said orthotic insert to an air pump for cyclic addition of air, and filling said ice boot of with coolant comprising ice and optionally salt for a time sufficient to cool said leg, connect.
